(19) United States
(12) Patent Application Publication
(10) Pub. No.: US 2015/0300323 A1
(43) Pub. Date: Oct. 22, 2015

(54) SYSTEM AND METHOD FOR COLLECTING FLUID LEAKING FROM A WIND TURBINE COMPONENT

(71) Applicants: Ulrich Neumann, Simpsonville, SC (US); Qiang Fu, Shanghai (CN)

(72) Inventors: Ulrich Neumann, Simpsonville, SC (US); Qiang Fu, Shanghai (CN)

(73) Assignee: General Electric Company, Schenectady, NY (US)

(21) Appl. No.: 14/342,409

(22) PCT Filed: Sep. 14, 2011
(86) PCT No.: PCT/CN2011/001556

§ 371 Date: Mar. 3, 2014

(51) Int. Cl. F03D 11/00

(52) U.S. Cl. CPC F03D 11/0075

(57) ABSTRACT

A system and method for collecting fluid leaking from a component of a wind turbine are disclosed. In one aspect, the system may include a flexible sheet (102) formed from a fluid resistant material. The flexible sheet may generally be supported at or adjacent to a leakage zone (104) defined below the component of the wind turbine (10).

### FIELD OF THE INVENTION

The present subject matter relates generally to wind turbines and, more particularly, to a system and method for collecting fluid leaking from wind turbine components.

### BACKGROUND OF THE INVENTION

Generally, a wind turbine includes a tower, a nacelle mounted on the tower, and a rotor coupled to the nacelle. The rotor generally includes a rotatable hub and a plurality of rotor blades coupled to and extending outwardly from the hub. Each rotor blade may be spaced about the hub so as to facilitate rotating the rotor to enable kinetic energy to be converted into usable mechanical energy, which may then be transmitted to an electric generator disposed within the nacelle for the production of electrical energy. Typically, a gearbox is used to drive the electric generator in response to rotation of the rotor. For instance, the gearbox may be configured to convert a low speed, high torque input provided by the rotor to a high speed, low torque output that may drive the electric generator.

In performing routine maintenance operations on a wind turbine, it is often necessary to disassemble the outer casing of a wind turbine gearbox to provide service workers physical access within the gearbox. This typically requires that the outer casing be split in half by separating adjacent sections of the casing at a vertical joint. Unfortunately, even when it is attempted to drain the oil contained within the gearbox prior to splitting the casing, a considerable amount of residual oil still remains within the casing. As such, when the outer casing is split, oil typically spills, drips and/or leaks out of the gearbox, thereby creating a slipping hazard on adjacent walking surfaces.

Due to size limitations of the tower and the nacelle, a conventional, rigid drip pan of the size needed to catch oil spilling from the gearbox simply cannot be installed within a wind turbine. As such, current methods for accommodating oil spills or leaks include laying out oil absorbing mats at locations within the wind turbine at which the oil pools after spilling or leaking from gearbox. However, these locations are typically along the walking surfaces of the wind turbine (e.g., walking decks disposed within the wind turbine tower). As such, the oil absorbing mats often create tripping hazards for service workers moving around within the wind turbine.

Accordingly, an effective system and method for collecting oil leaking from a gearbox would be welcomed in the art.

### BRIEF DESCRIPTION OF THE INVENTION

Aspects and advantages of the invention will be set forth in part in the following description, or may be obvious from the description, or may be learned through practice of the invention.

In one aspect, the present subject matter discloses a system for collecting fluid leaking from a component of a wind turbine. The system generally includes a flexible sheet formed from a fluid resistant material and means for supporting the flexible sheet at or adjacent to a leakage zone defined below the component of the wind turbine.

In another aspect, the present subject matter discloses a system for collecting fluid leaking from a component of a wind turbine. The system generally includes a flexible sheet formed from a fluid resistant material and at least one cable coupled between the flexible sheet and a plurality of anchor points spaced apart around a leakage zone defined below the component of the wind turbine.

In a further aspect, the present subject matter discloses a method for collecting fluid leaking from a component of a wind turbine. The method generally includes installing a flexible sheet of fluid resistant material at or adjacent to a leakage zone defined below the component of the wind turbine and supporting the flexible sheet at or adjacent to the leakage zone as fluid is collected by the flexible sheet.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine;

FIG. 2 illustrates a simplified, internal view of one embodiment of the nacelle of the wind turbine shown in FIG. 1;

FIG. 3 illustrates a top view of one embodiment of a system for collecting fluid leaking from a wind turbine component, particularly illustrating the system installed at the intersection of the bedplate and the tower of a wind turbine;

FIG. 4 illustrates a cross-sectional view of the system shown in FIG. 3 taken along line 4-4;

FIG. 5 illustrates a cross-sectional view of the system shown in FIG. 3 taken along line 5-5; and,

FIG. 6 illustrates a top view of another embodiment of a system for collecting fluid leaking from a wind turbine component, particularly illustrating the system installed at the intersection of the bedplate and the tower of a wind turbine.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a system and method for collecting one or more fluids leaking from a wind turbine component. Specifically, the present subject matter discloses a system for collecting oil and/or other fluids leaking from a wind turbine gearbox. In several embodiments, the system may include a fluid collection sheet configured to be spread out underneath the gearbox. In addition, the system may include one or more cables and/or any other suitable means for supporting the fluid collection sheet underneath the gearbox as oil and/or other fluids leak from the gearbox.

It should be appreciated that, although the disclosed system is generally described herein as being configured to collect oil and/or other fluids leaking from a wind turbine gearbox, the system may generally be utilized to collect any suitable fluid leaking from any suitable component of the wind turbine. For example, in one embodiment, the system may be utilized to collect lubricants, oil and/or other fluids leaking from a wind turbine generator.

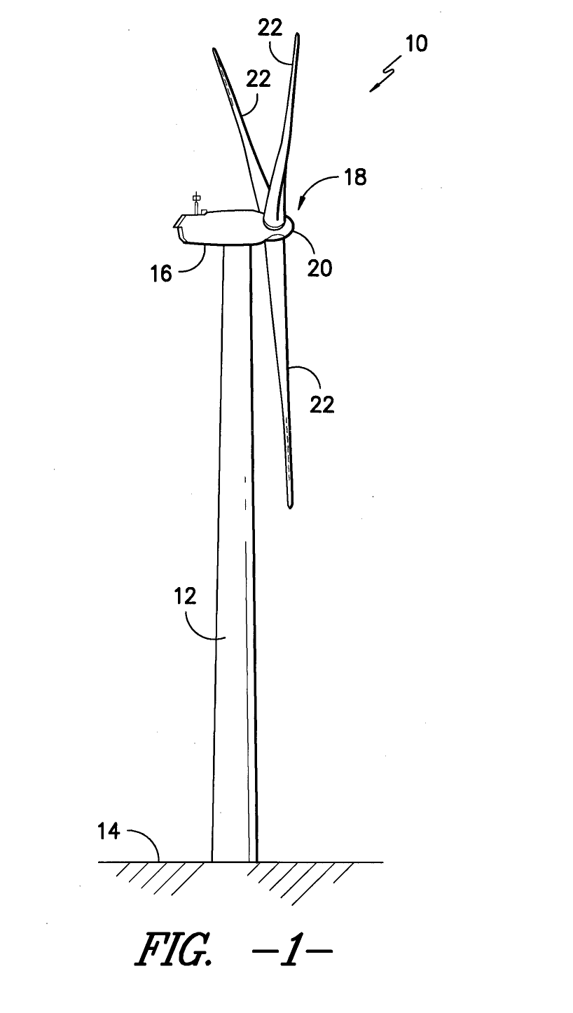

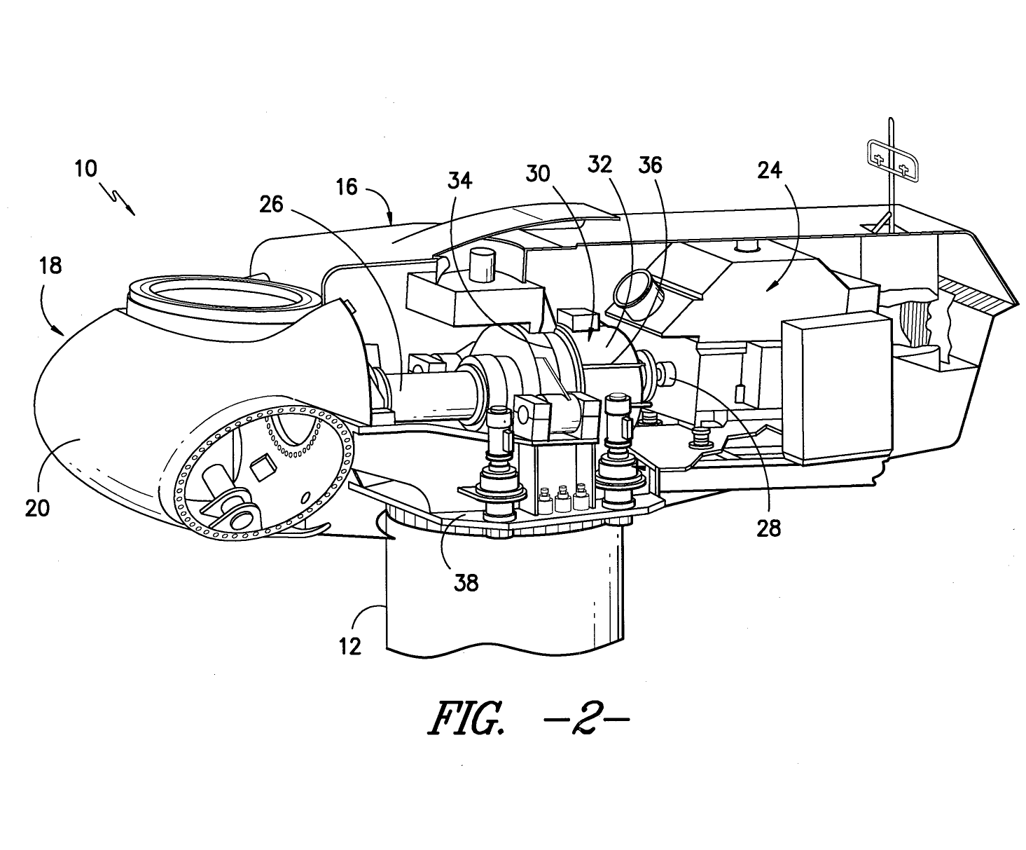

Referring now to the drawings, FIG. 1 illustrates perspective view of one embodiment of a wind turbine 10. As shown, the wind turbine 10 includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator 24 (FIG. 2) positioned within the nacelle 16 to permit electrical energy to be produced.

Referring now to FIG. 2, a simplified, internal view of one embodiment of the nacelle 16 of the wind turbine 10 shown in FIG. 1 is illustrated. As shown, a generator 24 may be disposed within the nacelle 16. In general, the generator 24 may be coupled to the rotor 18 of the wind turbine 10 for producing electrical power from the rotational energy generated by the rotor 18. For example, as shown in the illustrated embodiment, the rotor 18 may include a rotor shaft 26 coupled to the hub 20 for rotation therewith. The rotor shaft 26 may, in turn, be rotatably coupled to a generator shaft 28 of the generator 24 through a gearbox 30. As is generally understood, the rotor shaft 26 may provide a low speed, high torque input to the gearbox 30 in response to rotation of the rotor blades 22 and the hub 20. The gearbox 30 may then be configured to convert the low speed, high torque input to a high speed, low torque output to drive the generator shaft 28 and, thus, the generator 24.

It should be appreciated that the gearbox 30 may generally comprise any suitable gearbox known in the art. For instance, in several embodiments, the gearbox 30 may include multiple gear stages (e.g., a planetary gear stage and a helical gear stage), with each gear stage increasing the input speed and decreasing the input torque. Additionally, the gearbox 30 may include a lubrication system (not shown) or other means for circulating oil throughout the gearbox 30. As is generally understood, the oil may be used to reduce friction between the moving components of the gearbox 30 and may also be utilized to provide cooling for such components.

Moreover, the gearbox 30 may also include an outer shell or casing 32 designed to contain the oil, gear assemblies and other components of the gearbox 30. In several embodiments, the casing 32 may be formed from two or more casing sections joined together at a vertical joint(s) 34. Similarly, each casing section of the casing 32 may be formed from two or more sections jointed together at a horizontal joint(s) 36. As such, the gearbox casing 32 may be disassembled or decoupled in a variety of different ways to permit maintenance operations to be performed on the gearbox 30.

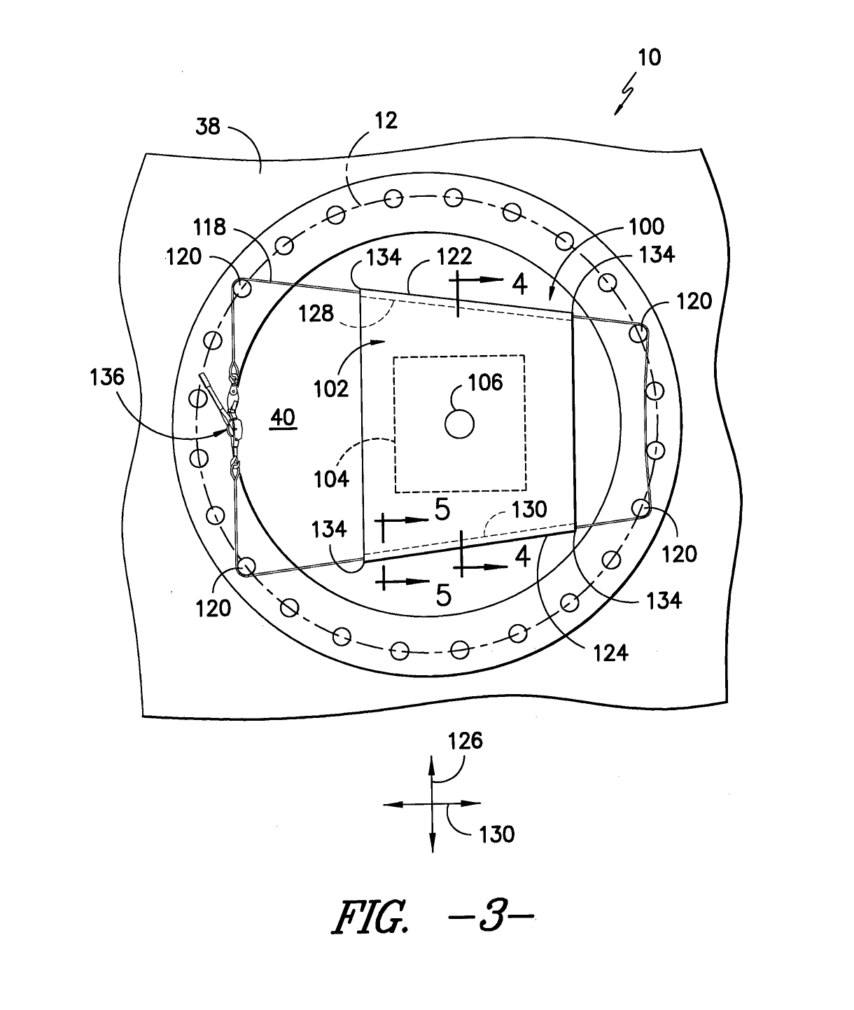

Additionally, as shown in FIG. 2, the gearbox 30 may generally be disposed above the wind turbine tower 12. Specifically, in several embodiments, the gearbox 30 may be coupled to a bedplate 38 of the nacelle 16 (e.g., by being coupled to the bedplate 38 through a suitable machine frame) so that the gearbox 30 is located directly above the intersection of the bedplate 38 and the tower 12. As such, when the gearbox casing 32 is disassembled during the performance of maintenance operations, residual oil contained within the gearbox 30 may leak through a tower opening 40 (FIG. 3) defined at the intersection of the bedplate 38 and the tower 12, thereby creating a slipping hazard on the walking surface(s) disposed below the bedplate 38 (e.g., the yaw deck and/or other walking decks disposed in the tower 12). It should be appreciated that the terms “leak” and “leaking” are used herein to refer generally to the occurrence of any fluid leaking, dripping and/or otherwise falling from the gearbox 30 or any other wind turbine component. Thus, oil gushing and/or splashing out of the gearbox 30 upon disassembly of the casing 32 may be considered oil “leaking” from the gearbox 30.

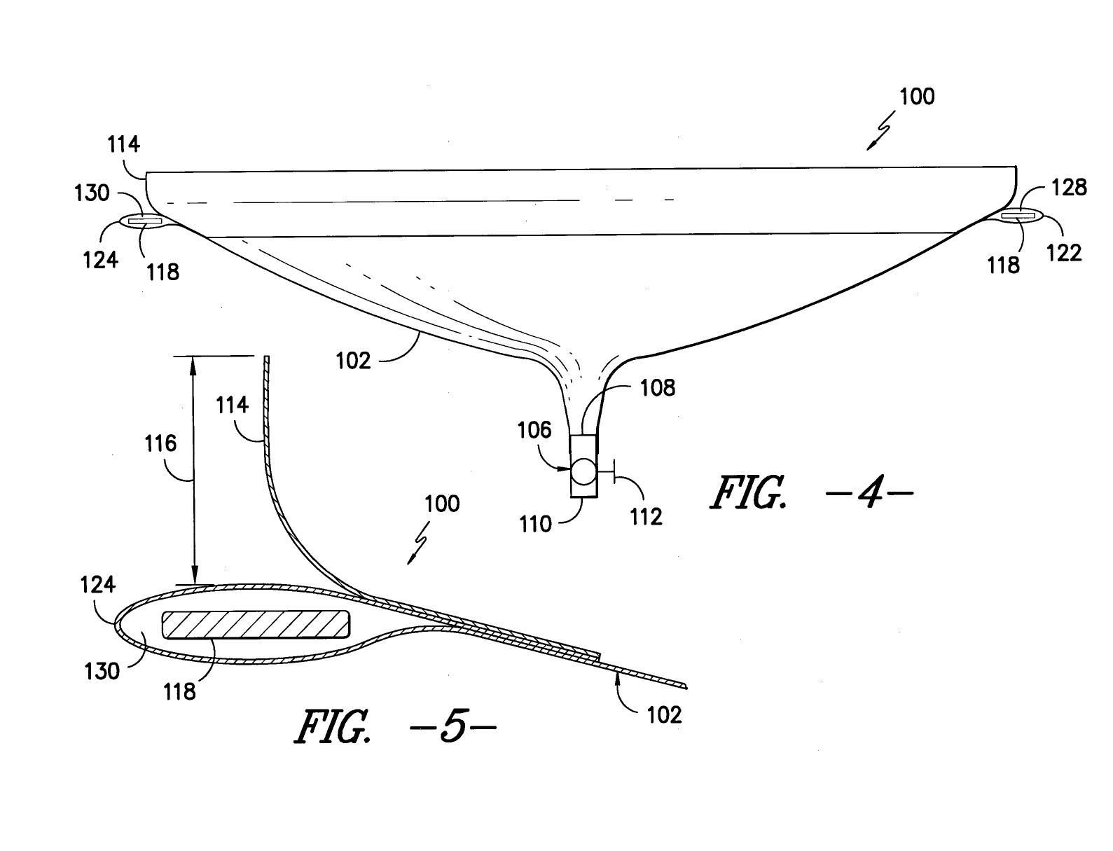

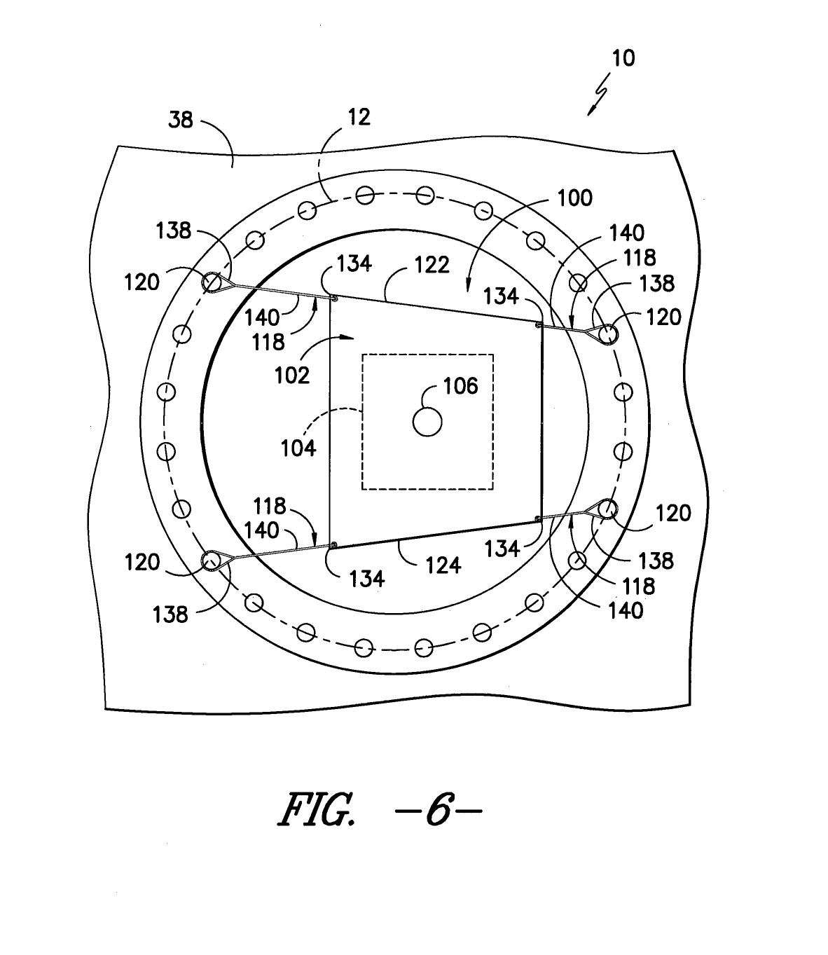

Referring now to FIGS. 3-5, various views of one embodiment of a system 100 for collecting oil and other fluids leaking from the gearbox 30 is illustrated in accordance with aspects of the present subject matter. Specifically, FIG. 3 illustrates a top view of various components of the system 100 installed within the nacelle 16, particularly illustrating an internal, top view of the nacelle 16 at the tower opening 40 with the gearbox 30 removed for purposes of illustration. Additionally, FIGS. 4 and 5, illustrate cross-sectional views of the system 100 shown in FIG. 3 taken along lines 4-4 and 5-5, respectively.

As shown, the system 100 generally includes a fluid collection sheet 102 configured to be spread out underneath the gearbox 30 so as to capture, contain and/or otherwise collect oil and/or other fluids leaking from the gearbox 30. In particular, the fluid collection sheet 102 may be configured to extend across an area that is equal to or greater than a leakage zone (indicated by the dashed box 104) of the gearbox 30. As used herein, the term “leakage zone” generally refers to a plane defined below a wind turbine component through which at least a portion of the fluid leaking from such component may pass. For instance, the leakage zone 104 of the gearbox 30 may be defined, for example, directly below its vertical joint(s) 34 or at any other suitable location at which oil and/or other fluids may leak from the gearbox 30. Additionally, as indicated above, in several embodiments, the gearbox 30 may be disposed directly above the tower opening 40 defined at the intersection of the bedplate 38 and the tower 12. Thus, as shown in FIG. 3, the leakage zone 104 of the gearbox 30 may generally be aligned with a portion of the tower opening 40. In such embodiments, the fluid collection sheet 102 may be generally configured to extend across the leakage zone 104, such as by being spread out and/or suspended across all or a portion of the tower opening 40, so that oil and/or other fluids leaking from the gearbox 30 may be captured, contained and/or collected by the sheet 102. It should be appreciated that, in embodiments in which the disclosed system 100 is utilized to capture fluids leaking from a wind turbine component other than the gearbox 30, the fluid collection sheet 102 may be configured to extend across an area that is equal to or greater than the leakage zone defined for such component.

In general, the fluid collection sheet 102 may be formed from any suitable fluid resistant material (e.g., an oil resistant material) and/or any suitable combination of materials that provide fluid resistance to the sheet 102. For instance, in several embodiments, the fluid collection sheet 102 may be formed from one or more polymer materials (e.g., various plastic materials such as polyethylene or polypropylene), rubberized materials, fabrics having a suitable fluid resistant coating (e.g., a cloth material such as canvas or polyester coated with urethane) and/or any other suitable fluid resistant material and/or combination of materials. In a particular embodiment of the present subject matter, the fluid collection sheet 102 may be configured as a conventional tarpaulin and, thus, may be formed from any fluid resistant material(s) typically used to form tarpaulins.

Additionally, in several embodiments, the material(s) used to form the fluid collection sheet 102 may be non-rigid or flexible. By manufacturing the fluid collection sheet 102 from a flexible material, the sheet 102 may be folded, rolled or otherwise arranged for easy transport up the wind turbine tower 12. Moreover, the flexible material may also permit the fluid collection sheet 102 to be installed in tight and/or non-planar areas of the nacelle 16. For instance, the area between the gearbox 30 and the tower opening 40 typically contain numerous objects (not shown) such as cables (e.g., power, date and fiber optic cables), gussets and/or other structural members. Thus, by configuring the fluid collection sheet 102 to be flexible, the sheet 102 may be folded, snaked or otherwise conformed in a manner that accommodates such objects.

Moreover, in several embodiments of the present subject matter, the fluid collection sheet 102 may include a drain 106 secured to a portion thereof for removing fluids collected by the sheet 102. For example, as shown in FIGS. 3 and 4, the drain 106 may be installed at a centralized location on the fluid collection sheet 102 to permit oil and/or other fluids pooling around the center of the sheet 102 to be drained therefrom. However, it should be appreciated that the drain 106 need not be installed at a central location on the fluid collection sheet 102 but may generally be installed at any suitable location on the sheet 102. In addition, in one embodiment, multiple drains 106 may be secured to portions of the fluid collection sheet 102 in order to drain fluids from the sheet 102 at differing locations.

In general, the drain 106 may have any suitable configuration that permits the fluid captured by the fluid collection sheet 102 to be expelled from the sheet 102. For example, in several embodiments, the drain 106 may comprise a pipe or other suitable conduit secured to and sealed within a corresponding opening (not shown) defined in the fluid collection sheet 102. The drain 106 may generally include an inlet 108 for receiving the fluids collected by the fluid retention sheet 102 and an outlet 110 for expelling such fluids. In such embodiments, it may be desirable for the outlet 110 to be threaded or otherwise configured to be attached to a separate hose or pipe (not shown) for directing the fluid transferred through the drain 106 to a suitable transfer vessel (e.g., an oil barrel or other suitable container) to permit efficient removal of the fluid from the wind turbine 10. In addition, as shown in FIG. 3, the drain 106 may also include a valve 112 (e.g., a ball valve) or other suitable device for controlling the flow of fluid through the drain 106. For instance, the valve 112 may be configured as a shut-off valve to permit the flow of fluid through the drain 106 to be turned off and on.

Additionally, the fluid collection sheet 102 may also include a splashguard 114 disposed around the outer perimeter of the sheet 102. As particularly shown in FIG. 5, the splashguard 114 may generally be configured to extend from the outer perimeter of the fluid collection sheet 102 so as to define a sidewall for the sheet 102. Specifically, as shown, the splashguard 114 may extend from the fluid collection sheet 102 at least partially in a vertical direction so as to define a height 116 above the sheet 102 As such, the splashguard 114 may be prevent the oil and other fluids leaking from the gearbox 30 from splashing and/or spilling outside the sheet 102.

It should be appreciated that the splashguard 114 may generally be formed from any suitable material and may be attached to the fluid collection sheet 102 using any suitable means known in the art. For example, in one embodiment, the splashguard 114 may be formed from the same or a similar material to that used to form the fluid collection sheet 102 and may be attached around the perimeter of the sheet 102 in a manner so that the splashguard 114 extends vertically to a suitable height 116 when the sheet 102 is spread out and/or suspended across the leakage zone 104. However, in an alternative embodiment, the splashguard 114 may be formed from a more rigid material, such as a semi-rigid or rigid plastic material.

In addition, referring still to FIGS. 3-5, the fluid collection sheet 102 may generally be configured to be maintained or otherwise supported at and/or adjacent to the leakage zone 104 using any suitable means known in the art. For example, in several embodiments, one or more cables 118 may be utilized to couple the fluid collection sheet 102 to one or more anchor points 120 spaced apart around the leakage zone 104. Thus, as shown in the illustrated embodiment, the fluid collection sheet 102 may be maintained or supported below the gearbox 30 using a cable 118 configured to extend or wrap around a plurality of anchor points 120 (e.g., a plurality of bolts, brakes assemblies and/or other existing hardware) spaced apart around the tower opening 40. Specifically, the cable 118 may be coupled to first and second sides 122, 124 of the fluid collection sheet 102 so that, as the cable 118 is wrapped around the perimeter defined by the anchor points 120, the sheet 102 spreads out in a sidewise direction (indicated by arrow 126) across the leakage zone 104. For instance, as shown in FIG. 5, first and second channels or loops 128, 130 may be formed along the first and second sides 122, 124, respectively (e.g., by folding over the edges of the fluid collection sheet 102 at the first and second sides 122, 124 and securing the edges to a portion the sheet 102) to permit the cable 118 to be coupled to the sheet 102. As such, the cable 118 may be inserted through the first and second loops 128, 130 and subsequently wrapped around the anchor points 120 in order to maintain and/or support the fluid collection sheet 102 at or adjacent to the leakage zone 104.

In such an embodiment, it should be appreciated that the cable 118 may be slidably or fixedly coupled within the first and second loops 128, 130. For example, by slidably coupling the cable 118 within the loops 128, 130 (e.g., by simply inserting the cable 118 through the loops 128, 130), the position of the fluid collection sheet 102 may be adjusted in a widthwise direction (indicated by arrow 132) relative to the leakage zone 104 by sliding the sheet 102 in such direction relative to the cable 118. Alternatively, by fixedly coupling the cable 118 within the loops 128, 130 (e.g. by sewing or otherwise securing the cable 118 within the loops 128, 130), the fluid collection sheet 102 may be spread out in the widthwise direction 132 across the leakage zone 104 as the cable 118 is wrapped tightly around the anchor points 120.

It should also be appreciated that, in alternative embodiments, the cable 118 need not be coupled to the fluid collection sheet 102 through the illustrated loops 128, 130 but may generally be coupled to the sheet 102 using any suitable means known in the art. For example, in one embodiment, the cable 118 may be coupled to the fluid collection sheet 102 using suitable fasteners and/or adhesives. Alternatively, the cable 118 may be sewn to the fluid collection sheet 102 and/or attached to one or more holes (not shown) defined through the sheet 102 (e.g., reinforced grommets located at the corners 134 and/or along the sides 122, 124 of the sheet 102).

Additionally, in several embodiments, the disclosed system 100 may also include a tensioning device 136 for tensioning the cable 118 around the anchor points 120. For example, in one embodiment, the cable 118 may be configured the same as or similar to a tie down strap (e.g., a cinch, compression and/or ratchet strap), with the ends of the cable 118 being coupled to the tensioning device 136 (e.g., a ratchet, manual cinch or similar device) in order to tension the cable 118 around the anchor points 120 and, thus, maintain and/or support the sheet 102 at a suitable position at or adjacent to the leakage zone 104. However, in an alternative embodiment, the ends of the cable 118 may simply be secured together (e.g., by tying the ends of the cable 118 together) or the cable 118 may otherwise held in place to relative to the anchor points 120 to ensure that the fluid collection sheet 102 is properly supported and/or maintained at or adjacent to the leakage zone 104 (e.g., by securing the ends of the cable 118 at one or more of the anchor points 120).

It should be appreciated that, in alternative embodiments, each side 122, 124 of the fluid collection sheet 102 may be supported by a different cable 118. Specifically, instead of providing a single cable 118 extending around the anchor points 120, a first cable (not shown) may be coupled to the first side 122 of the fluid collection sheet 102 (e.g. by being coupled through the first loop 128) and may extend between two or more anchor points 120. Similarly, a second cable (not shown) may be coupled to the second side 124 of the fluid collection sheet 102 (e.g. by being coupled through the second loop 130) and may extend between two or more anchor points 120.

Referring now to FIG. 6, another embodiment of a suitable arrangement for supporting the fluid collection sheet 102 at and/or adjacent to the leakage zone 104 is illustrated in accordance with aspects of the present subject matter. As shown, a plurality of cables 118 may be coupled between the fluid collection sheet 102 and the anchor points 120, with each cable 118 including a first end 138 coupled to a portion of the sheet 102 and a second end 140 coupled to one of the anchor points 120. For example, as shown in FIG. 6, the first end 138 of each cable 118 may be attached to one of the corners 134 of the sheet 102, such as by being attached to a reinforced grommet disposed at each corner 134. Similarly, the second end 140 of each cable 118 may be secured one of the anchor points 120, such as by tying the second end 140 of each cable 118 to a corresponding anchor point 120. As such, the fluid collection sheet 102 may be properly aligned relative to the leakage zone 104 by adjusting the length that each cable 118 extends between the sheet 102 and each anchor point 120.

In further embodiments, it should be appreciated that the fluid collection sheet 102 may be maintained or otherwise supported at or adjacent to the leakage zone 104 using any other suitable means known in the art. For example, instead of the cables 118 described above, various other coupling devices, such as clips, hooks, tie downs, support rods, brackets and the like, may be coupled between the fluid collection sheet 102 and the anchor points 120 to support the sheet 102 at or adjacent to the leakage zone 104. In another embodiment, the dimensions of the fluid collection sheet 102 may be chosen so that it extends over an area larger than the area defined by the tower opening 40. In such an embodiment, the fluid collection sheet 102 may be maintained and/or supported at or adjacent to the leakage zone 104 by simply placing one or more weighted objects (e.g., one or more sandbags, fluid filled containers or other suitable weighted objects) onto the portions of the sheet 102 extending beyond the area defined by the tower opening 40. For instance, weighted objects may be placed at each corner 134 of the fluid collection sheet 102 to anchor the sheet 102 to the bedplate 38 or any other suitable surface of the wind turbine 10. In a further embodiment, the fluid collection sheet 102 may be held in place by one or more service workers located within the nacelle 16, such as by having service workers hold the sides 122, 124 and/or corners 134 of the sheet 102 or by having service workers stand on the sides 122, 124 and/or corners 134 of the sheet 102.

It should be appreciated that, as used herein, the term “cable” refers generally to any length of material that may be configured to function as described herein. As such, the cables 118 of the present subject matter may include, but are not limited to, any cables, wires, straps, ropes, chains and/or lines formed from any suitable material that is capable of supporting the fluid collection sheet 102 at or adjacent to the leakage zone 104. For example, in a particular embodiment of the present subject matter, the cables 118 may comprise suitable webbing, such as flat straps formed from twisted, braided and/or woven natural fibers (e.g., hemp and cotton) and/or or synthetic fibers (e.g., polypropylene, nylon and polyesters).

Moreover, it should be appreciated that, as used herein, the term “anchor point” refers generally to any point within the wind turbine 10 from which the fluid collection sheet 102 is supported. Thus, in several embodiments, each anchor point 120 may generally be defined by any suitable object to which the fluid collection sheet 102 is directly and/or indirectly coupled. For instance, in embodiments where a cable(s) 118 is utilized to support the fluid collection sheet 102 at or adjacent to the leakage zone 104, suitable anchor points 120 may be defined by any suitable wind turbine components spaced apart around the leakage zone, such as existing hardware and structural members of the wind turbine 10 (e.g., machine frames, bolts, brackets, brake assemblies and the like). Alternatively, the anchor points 120 may be formed within the wind turbine 10 specifically for the purpose of supporting the fluid collection sheet 102. For instance, in one embodiment, a plurality of holes may be tapped within the bedplate 38 and/or within any other suitable wind turbine component for receiving a plurality of bolts, hooks, brackets and/or the like configured to define the anchor points 120 for the cable(s) 118. Moreover, in embodiments in which weighted objects are utilized to support the fluid collection sheet 102 at or adjacent to the leakage zone 104, the anchor points 120 may generally be defined at the point of contact between the fluid collection sheet 102 and the weighted objects. Similarly, when service workers are utilized to support the fluid collection sheet 102, the service workers may generally serve as the anchor points 120 for the sheet 102.

As indicated above, the present subject matter is also directed to a method for collecting fluid leaking from a component of a wind turbine. In several embodiments, the method may generally include installing a fluid collection sheet 102 at or adjacent to a leakage zone 104 defined below a wind turbine gearbox 30 and supporting the sheet 102 at or adjacent to the leakage zone 104 as fluid is collected by the sheet 102.

In addition, the present subject mater also discloses a method for performing a maintenance operation on a wind turbine gearbox 30. In several embodiments, the method may include installing a fluid collection sheet 102 at or adjacent to a leakage zone 104 defined below the gearbox 30, dissembling at least a portion of the gearbox 30 (e.g., by disassembling the casing 32 of the gearbox 30 at the vertical joint 34) and supporting the sheet 102 at or adjacent to the leakage zone 104 as fluid leaks from the gearbox 30.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for collecting fluid leaking from a component of a wind turbine, the system comprising:
a flexible sheet formed from a fluid resistant material; and
means for supporting the flexible sheet at or adjacent to a leakage zone defined below the component of the wind turbine.

2. The system of claim 1, wherein the means for supporting the flexible sheet at or adjacent to the leakage zone comprises a cable coupled between the flexible sheet and a plurality of anchor points spaced apart around the leakage zone.

3. The system of claim 2, wherein the cable is configured to extend around the plurality of anchor points.

4. The system of claim 3, further comprising a tensioning device configured to tension the cable around the plurality of anchor points.

5. The system of claim 2, wherein the flexible sheet includes a first side and a second side, a portion of the cable being coupled to the first and second sides.

6. The system of claim 5, wherein the first side defines a first loop and the second side defined a second loop, the cable being configured to extend through the first and second loops.

7. The system of claim 2, wherein the means for supporting the flexible sheet at or adjacent to the leakage zone comprises a plurality of cables coupled between the flexible sheet and the plurality of anchor points.

8. The system of claim 7, wherein each of the plurality of cables includes a first end coupled to a portion of the flexible sheet and a second end coupled to one of the plurality of anchor points.

9. The system of claim 1, further comprising a drain secured to a portion of the flexible sheet.

10. The system of claim 9, wherein the drain includes a valve configured to control the flow of fluid through the drain.

11. The system of claim 1, further comprising a splashguard disposed around the perimeter of the flexible sheet.

12. The system of claim 1, wherein the fluid resistant material comprises at least one of a polymer material, a rubberized material and a fabric having a fluid resistant coating.

13. The system of claim 1, wherein the leakage zone is generally aligned with a portion of a tower opening of the wind turbine.

14. The system of claim 1, wherein the component comprises a gearbox of the wind turbine.

15. The system of claim 14, wherein the fluid comprises oil.

16. A system for collecting fluid leaking from a component of a wind turbine, the system comprising:
a flexible sheet formed from a fluid resistant material; and
at least one cable coupled between the flexible sheet and a plurality of anchor points spaced apart around a leakage zone defined below the component of the wind turbine.

17. A method for collecting fluid leaking from a component of a wind turbine, the method comprising:
installing a flexible sheet of fluid resistant material at or adjacent to a leakage zone defined below the component of the wind turbine;
supporting the flexible sheet at or adjacent to the leakage zone as fluid is collected by the flexible sheet.

18. The method of claim 17, further comprising draining the fluid collected in the flexible sheet using a drain secured to a portion of the flexible sheet.

19. The method of claim 17, wherein supporting the flexible sheet at or adjacent to the leakage zone as fluid is collected by the flexible sheet comprises coupling a cable between the flexible sheet and a plurality of anchor points spaced apart around the leakage zone.

20. The method of claim 17, wherein supporting the flexible sheet at or adjacent to the leakage zone as fluid is collected by the flexible sheet comprises coupling a plurality of cables between the flexible sheet and a plurality of anchor points spaced apart around the leakage zone.
